(19) United States
(12) Patent Application Publication
(10) Pub. No.: US 2006/0031471 A1
(43) Pub. Date: Feb. 9, 2006

(54) Web based system for reporting operating conditions impacted by selected events

(76) Inventors: Allen H. Golland, New City, NY (US); Richard E. Bardsley, Orlando, FL (US); Steve L. Crook, Lake Mary, FL (US); Bonnie C. Eicher, Orlando, FL (US); Mayme G. Clinkenbeard, Oviedo, FL (US)

Correspondence Address: WELSH & KATZ, LTD, 120 S RIVERSIDE PLAZA, 22ND FLOOR, CHICAGO, IL, 60606, US

(21) Appl. No.: 10/883,269

(22) Filed: Jul. 1, 2004

(51) Int. Cl. G06F 15/173

(52) U.S. Cl. 709/224

(57) ABSTRACT

A web-based business-condition reporting system that enables a plurality of users to enter into a database, via an Intranet or the Internet, status information as to the impact of an event on performance of a business entity. The information can be retrieved for analysis from a plurality of disparate locations.

### FIELD OF THE INVENTION

The invention pertains to systems and methods for reporting operating conditions impacted by selected events. More particularly, the invention pertains to web-based systems and methods for enabling individuals, who might be geographically separated, to report the impact of selected events on an entity's ability to carry out its normal or expected functions.

### BACKGROUND OF THE INVENTION

There has been an ongoing need to enable representatives of an organization or an entity to report or otherwise communicate the existence of significant events and their effects on operating conditions. The events might be natural or man-made, and may require days, weeks or months for the entity to implement alternatives or to resolve or to recover from. Historically, such activities have been carried out using known communications capabilities such as e-mail, faxes sent using the switched telephone network, audible communications using a land line based switched telephone network as well as audible communications via one or more cellular telephone networks. Prior communication systems and methods have unfortunately created delays and bottlenecks in providing the necessary information in a timely fashion to vendors, employees, stakeholders or other interested parties.

Events could include chemical, biological, radiological or nuclear events, explosions, strikes, supply chain disruptions, fire, extended power outages or hostage situations. Other events include assaults on an operation or attempts to improperly obtain information, as well as the impact of a virus on information systems. Yet other events without limitation include earthquakes, weather events or medical events. The resulting negative impacts on business or entity operations can include an inability to achieve mission critical milestones, an inability to deliver key products, loss of proprietary, competitive, sensitive or classified information, a loss of critical resources, negative impacts on supply chains, as well as a temporary or permanent loss of entire sites or facilities.

There continues to be an unmet need for systems and methods which would enable representatives of an entity or an organization to report or communicate the status or impact of a significant event, natural or man made, on the organization's or entity's abilities to carry out its normal or expected function(s). Preferably, the communications could be transmitted from or received at primary, secondary or other remote locations without having to create or implement a dedicated communications system to take the place of previously used primary communications systems. It would also be desirable to be able to retrieve any previously submitted status information indicative of the ongoing response of the entity or organization in resolving or recovering from the subject event.

### SUMMARY OF THE INVENTION

A web-based reporting system enables a plurality of reporters to input, simultaneously or sequentially, status information pertaining to any significant event which may have a negative impact on business or entity function or operation from initial response to overall recovery. This information can be entered and accessed from a plurality of sites, thereby enabling stakeholders, as authorized, to retrieve such information in real time.

### BRIEF DESCRIPTION OF THE DRAWINGS

FIG. 1 is a block diagram of a system in accordance with the invention;

FIGS. 2A-2G taken together, are flow diagrams depicting a method in accordance with the invention; and

FIGS. 3A-3X are screens further illustrating various aspects of the invention.

### DESCRIPTION OF THE PREFERRED EMBODIMENTS

While this invention is susceptible of embodiments in many different forms, there are shown in the drawing and will be described herein in detail specific embodiments thereof with the understanding that the present disclosure is to be considered as an exemplification of the principles of the invention, including the best mode of practicing the invention, and is not intended to limit the invention to the specific embodiments illustrated.

Systems and methods in accordance with the invention facilitate real time reporting of business operations, and any significant event which may have a negative effect on such operations, from initial response to overall recovery. The negative impacts of any such event on business or entity activities or operations could include an inability to achieve mission critical milestones as well as inability to deliver key products in accordance with those milestones, a loss of proprietary, competitive, sensitive or classified data, a loss of critical resources, impact to the supply chain as well as loss of entire sites or individual facilities.

The severity of a given event relative to a site's ability to conduct normal operations and the anticipated recovery time can be reported on a real time basis in terms of color coded status elements. For example, red, yellow and green status elements can be used based on severity and forward looking recovery time.

The present system and method of reporting can be used by one or more corporate or entity sites simultaneously by business/site within each business area, or by geographic location. Either may be selected through an appropriate screen.

Multiple authorized users provide an unlimited update capability. Additionally, interested parties or users can ascertain business condition status and anticipated recovery as needed via a computer network such as the Internet.

Systems in accordance with the invention can be implemented as stand alone or self-contained web applications having minimal dependencies on other applications to implement key functionality. It will be understood that such systems could also be implemented to run in conjunction with one or more browsers, all without limitation and without departing from the scope and spirit hereof.

In accordance with the invention, a communications system is provided which can be used to report, in connection with one or more significant events, when other methods or systems may not be available. The system supports multiple simultaneous reporters as well as multiple situation analyzers.

In one embodiment, a chat function can be provided. Authorized parties can send point to point messages between business unit emergency operation centers or other designated locations all without limitation. Alternately, broadcast messages can be sent from one reporting center to a plurality of receiving locations simultaneously. The number of receiving centers or locations which are to receive broadcast messages is user definable via a graphical user interface.

In another embodiment, a message board capability can be provided. The message board can be viewed as desired or needed by all reporting entities. Messages can be posted with time and date indicia and can be reviewed by all logged on users. This functionality can be self-contained within the system and need not rely on external applications to implement its functions.

In another aspect of the invention, all received data are date and time stamped and can be subsequently retrieved by any authorized user. The archiving function can be useful during changes in command structure, emergency operations center handoffs and post-event analysis of the incident so as to provide for future improvements.

In yet another aspect of the invention, status entries can be received from multiple reporting entities simultaneously. The results thereof can be displayed in accordance with one or more hierarchical organizational structures and/or geographical regions in static or continuously scrolling summary views via graphical user interface. Access can be provided through any Internet enabled connection using devices such as laptops/desktop computers, personal digital assistants, cellular telephones or any other similar device having wired or wireless access to the Internet.

It will also be understood that passwords or other authorizing methodologies are used to provide security for the system all without limitation. Further, if desired, encryption can be used in connection with data transmissions to further enhance security. While useful, such details are not limitations of the present invention.

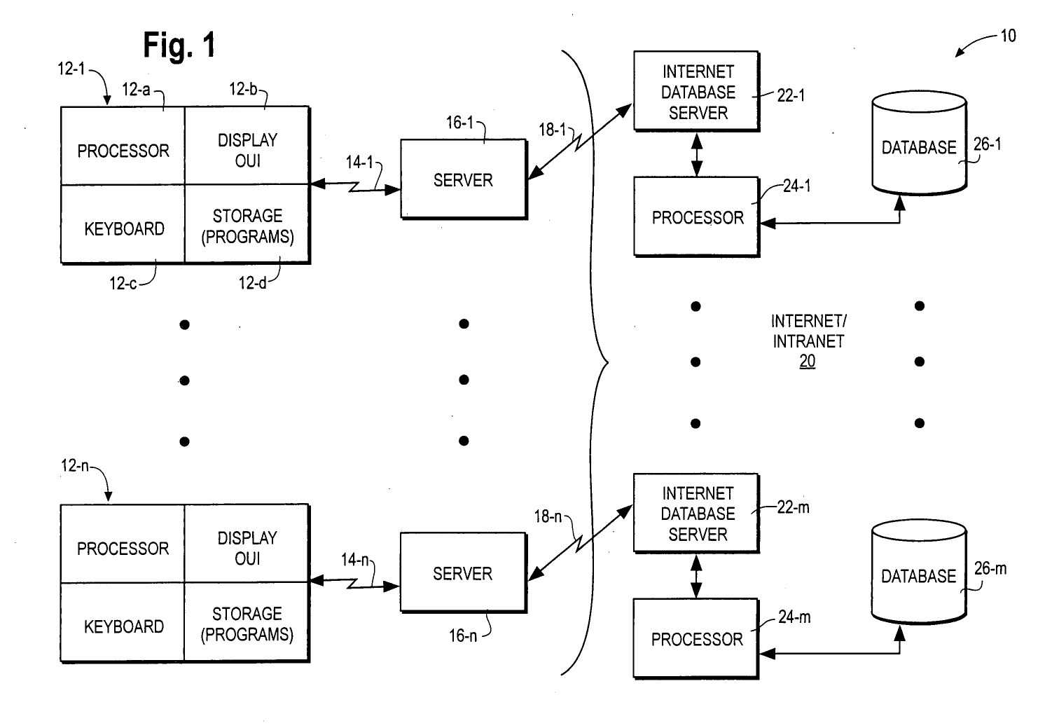

FIG. 1 illustrates an exemplary web based application and system 10 in accordance with the invention. System 10 includes a plurality of input/output devices such as 12-1 . . . 12-n which need not be identical. The devices 12-1 . . . 12-n can be used to either enter reporting information as to status or operating condition of a business or other entity or to retrieve previously entered information for analysis purposes.

The illustrative devices such as 12-1 incorporate a programmable processor 12a, display device 12b, input device such as illustrative keyboard 12c, and storage for local data and programs 12d. Local software (i.e., software stored locally at such a device) can include graphical user interface software.

Each of the units 12-1 . . . 12-n can be coupled via wired or wireless communication medium such as 14-1 . . . 14-n to a respective Internet service provider or server such as 16-1 . . . 16-n. Together, an input/output device and a server represent a reporting device. Those of skill will understand that the communications media 14-1 . . . 14-n whether wired or wireless are not limitations of the present invention. Nor, are the details of the Internet/server service provider facility 16-1 . . . 16-n.

In accordance with the invention, the input/output units 12-1 . . . 12-n can be placed in communication via Internet/server service provider 16-1 . . . 16-n and communication link 18 to Internet 20, with one or more database servers 22-1 . . . 22-m coupled thereto.

The respective servers, such as 22-1 can be in communication with system or database processor 24-1, which in turn maintains some or all of the information being reported in a respective database 26-1 . . . 26-m. Those of skill in the art will understand that the systems 24-1 . . . 24-m can be the same or different and could be redundant to provide backup and additional security. Similarly, databases 26-1 . . . 26-m could also be the same or different and could provide redundancy of data being recorded in connection with one or more events for enhanced system security.

It will also be understood that software in accordance with the present invention can be present at a variety of sites all without limitation. For example, on the client side, devices 12-1 . . . 12-n could contain local code or executable instructions for carrying out local functions as required for purposes of presenting screens, via a local graphical user interface, receiving information from a user, and carrying out transmissions with respective servers such as server 16-1. Similarly, the server such as 16-1 can incorporate software for purposes of communicating with one or more input/output client side devices such as 12-1 . . . 12-n, as well as for carrying out communications via the Internet 20 with displaced processors 24-1 . . . 24-m, all without limitation.

Thus, in accordance with the system 10, a user need only have access to an Internet enabled input device, such as a device 12-1 . . . 12-n to report status entries in connection with one or more events of interest. System 10 includes software for purposes of communicating with one or more input/output client side devices, such as 12-1 . . . 12-n, as well as for carrying out communications via the Internet 20 with displaced processors 24-1 . . . 24-m, all without limitation.

Those individuals interested in accessing previously reported status data, only need an Internet enabled access device such as 12-n to be able to retrieve any previously entered information from the databases 26-1 . . . 26-m for situation analysis. Similarly, the input/output devices such as 12-1 . . . 12-n provide access to message board functionality as well as internal direct messaging or chat functionality between authorized individuals. Reporting devices such as 12-1 . . . 12-n can also broadcast messages to one or more other devices simultaneously.

Those of skill in the art will understand that the location of various software elements of the system 10 are not limitations of the present invention. Software can be executed on the client side at the input/output devices such as 12-1 . . . 12-n or, on the respective web server such as at server 16-i as appropriate without limitation and without departing from the spirit and scope of the present invention. Similarly, if desired, some of the reporting information could be maintained on local databases such as 12-d in addition to being forwarded to system wide databases such as 26-1 . . . 26-m, all without limitation.

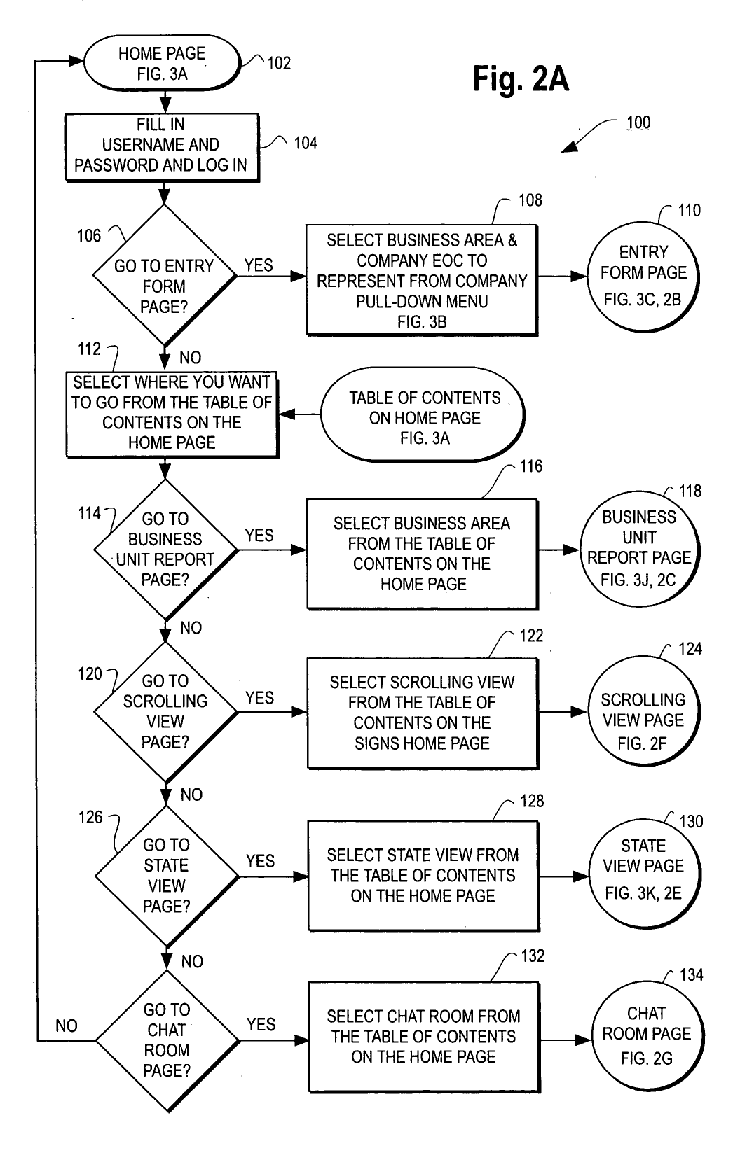

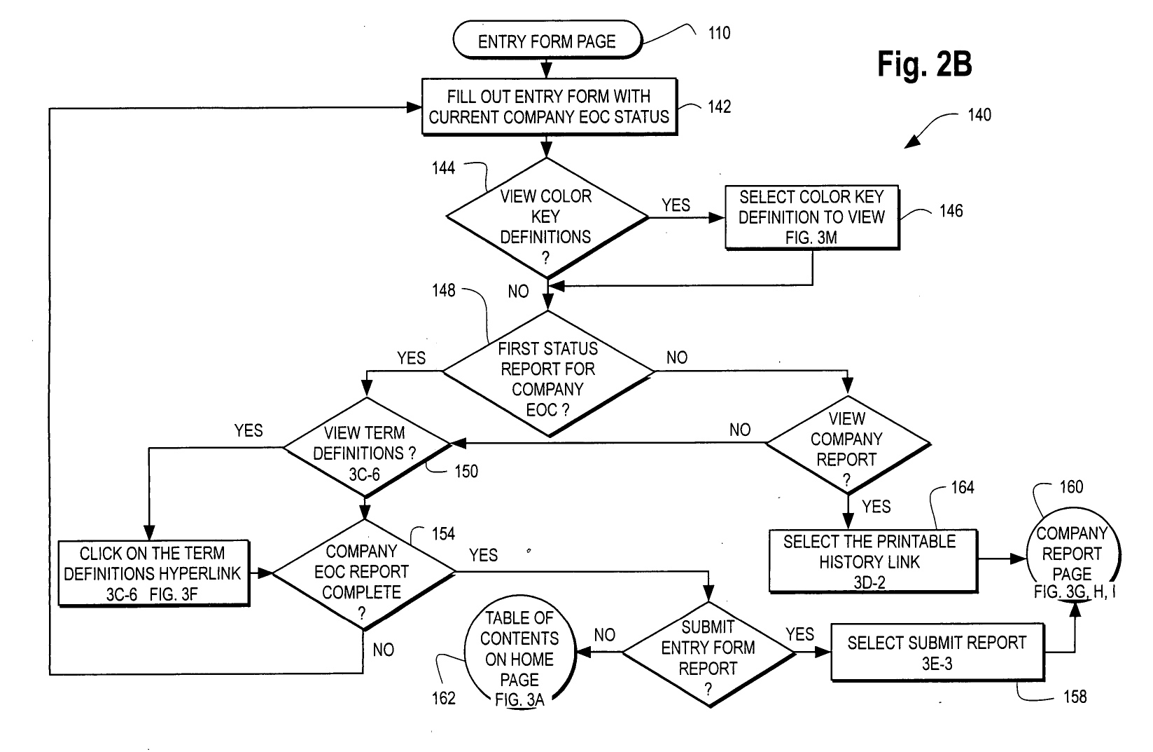

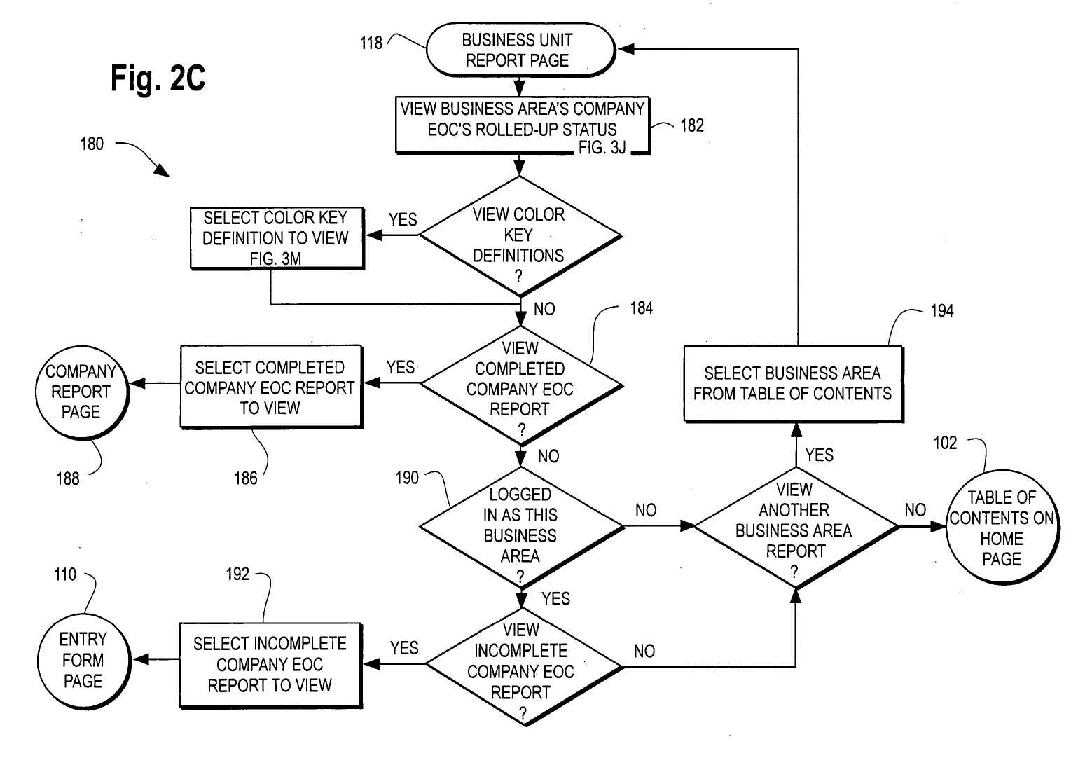

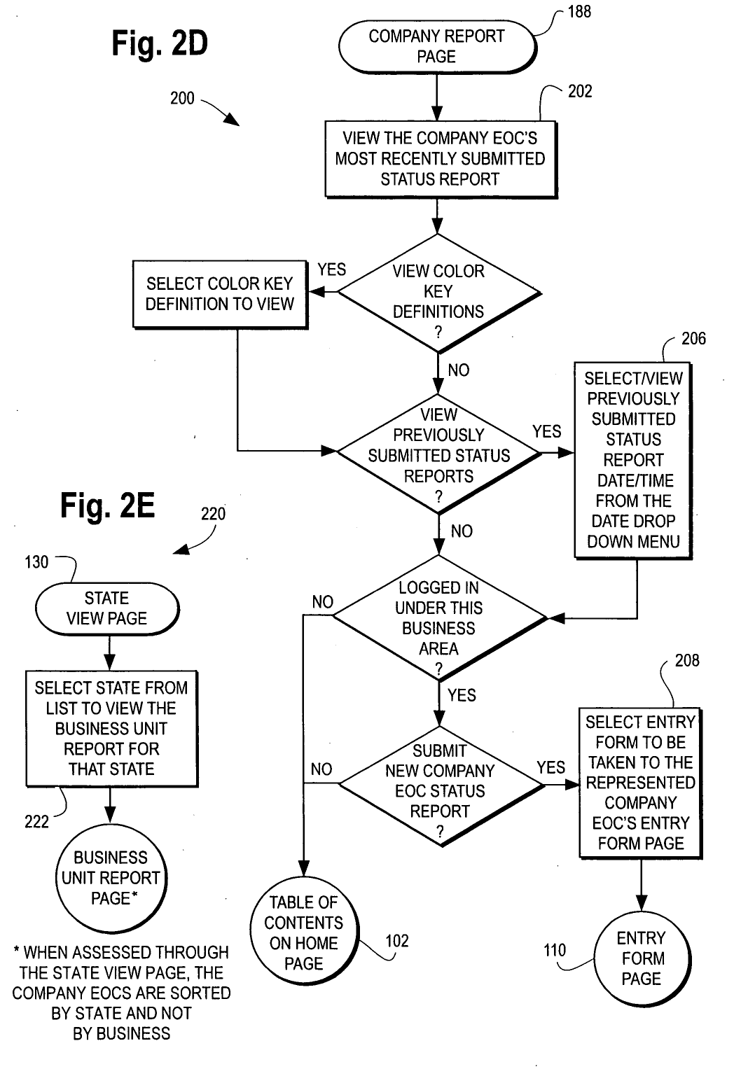

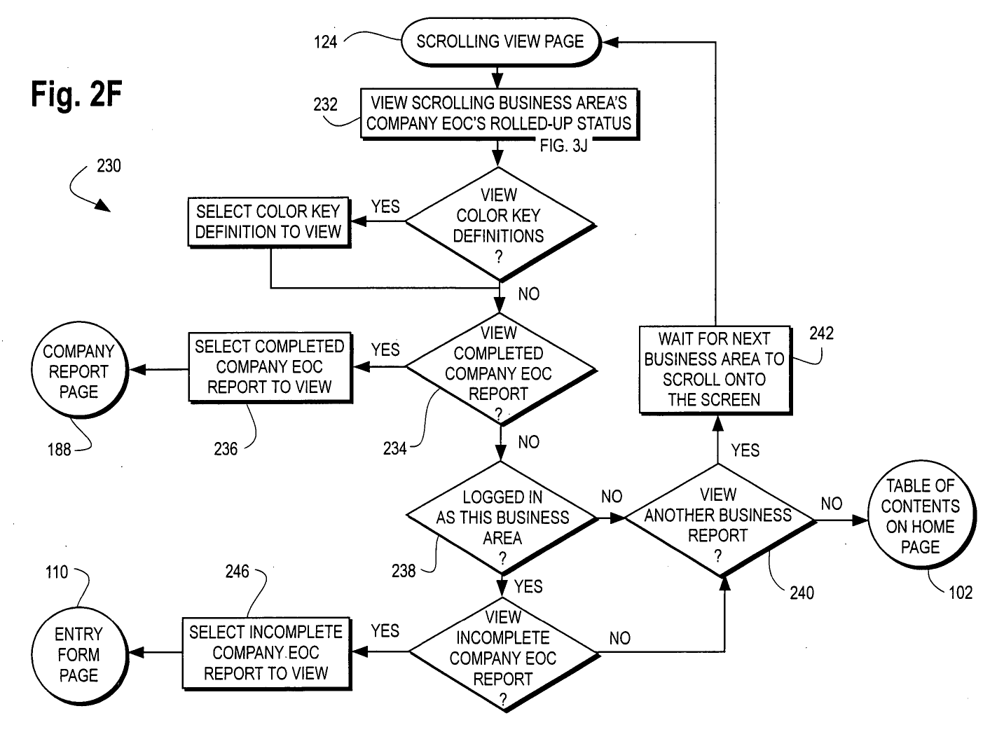

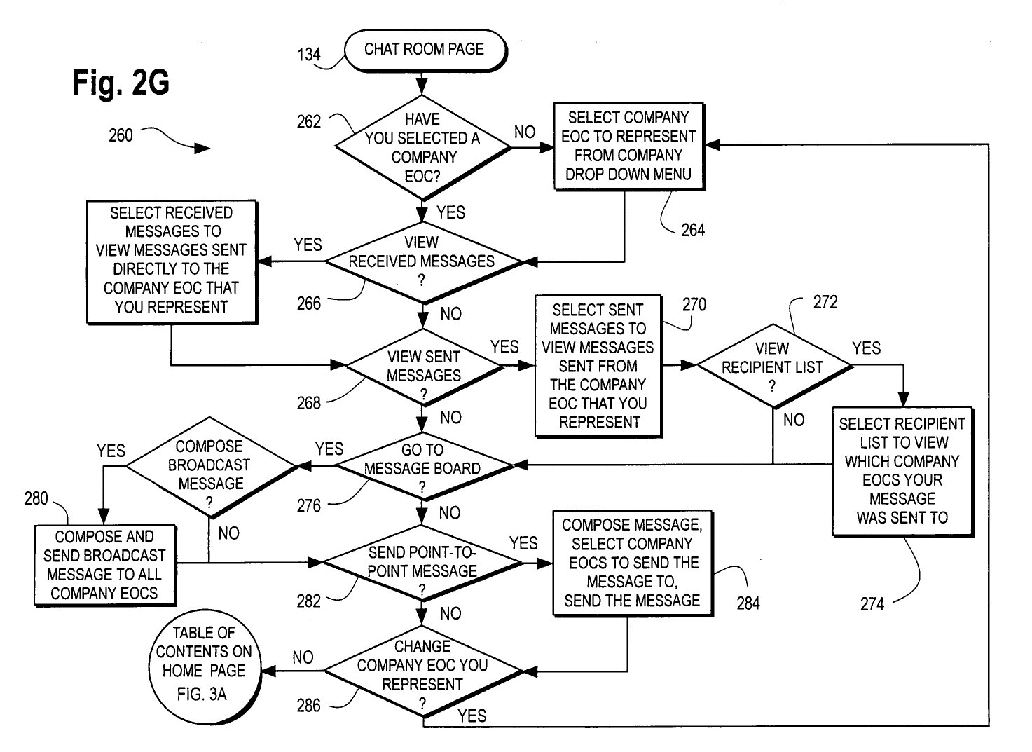

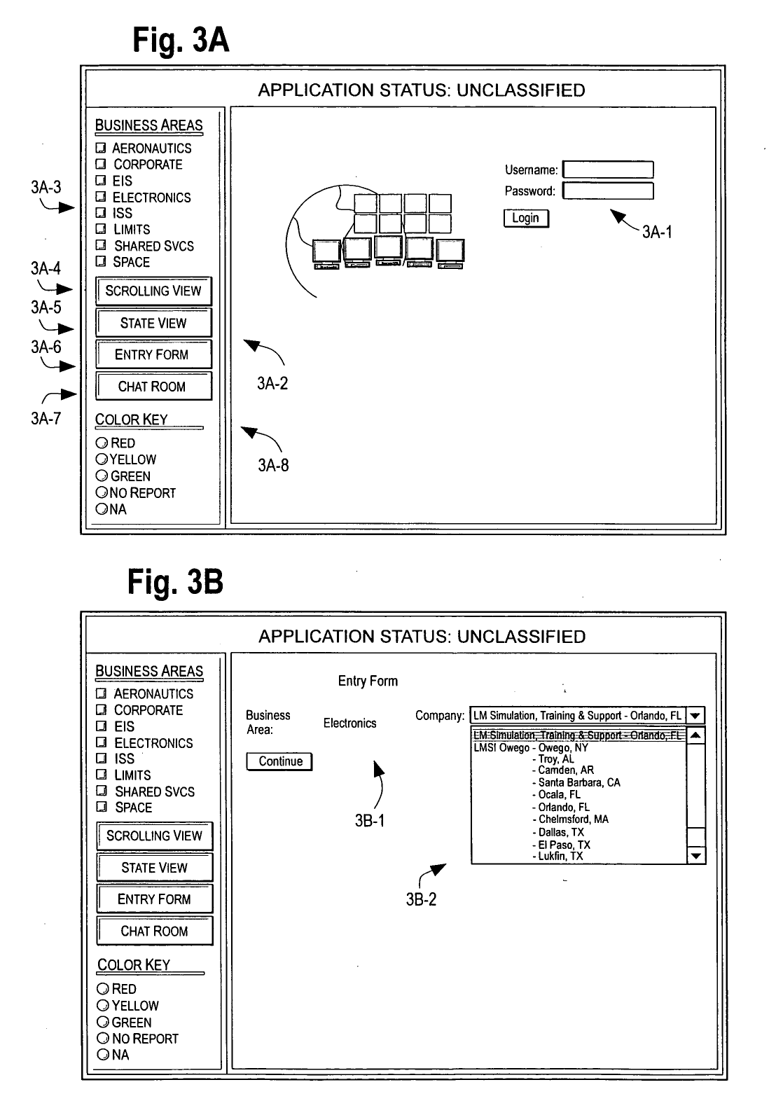

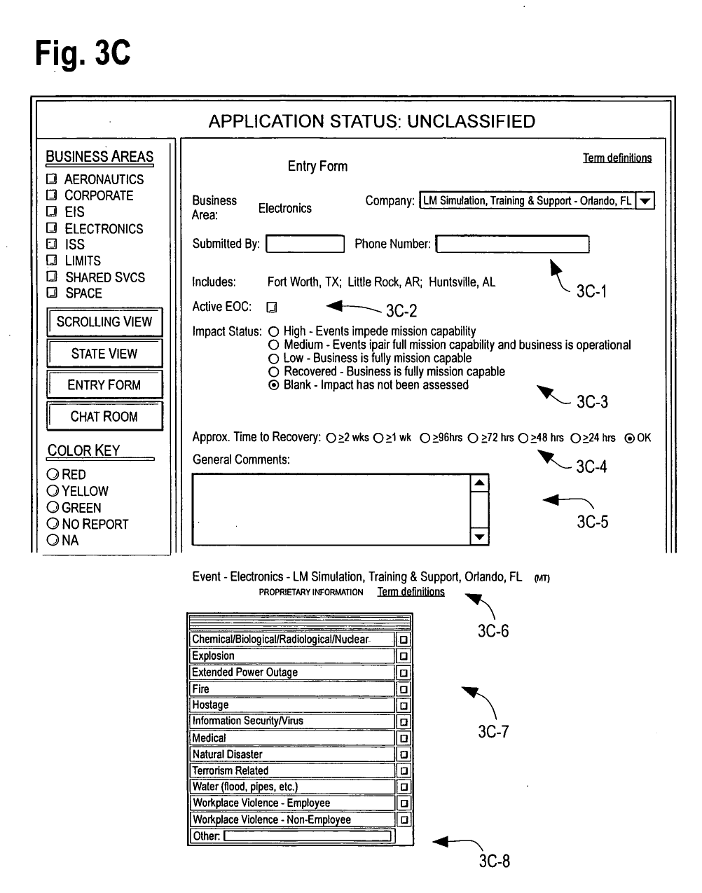

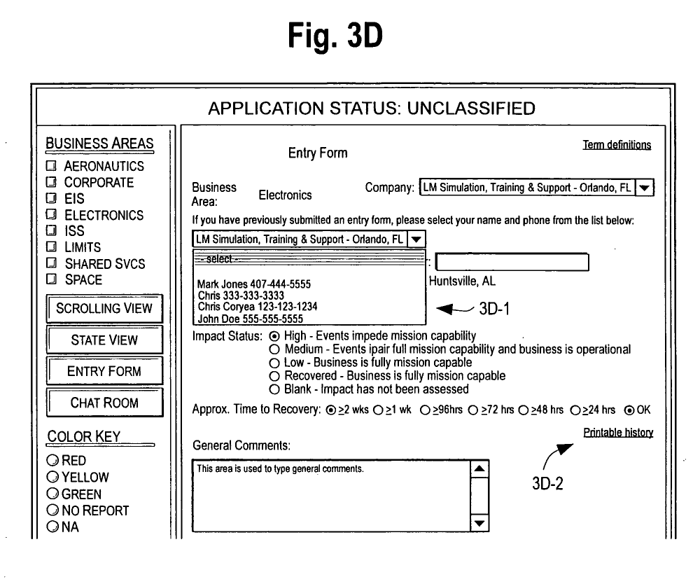

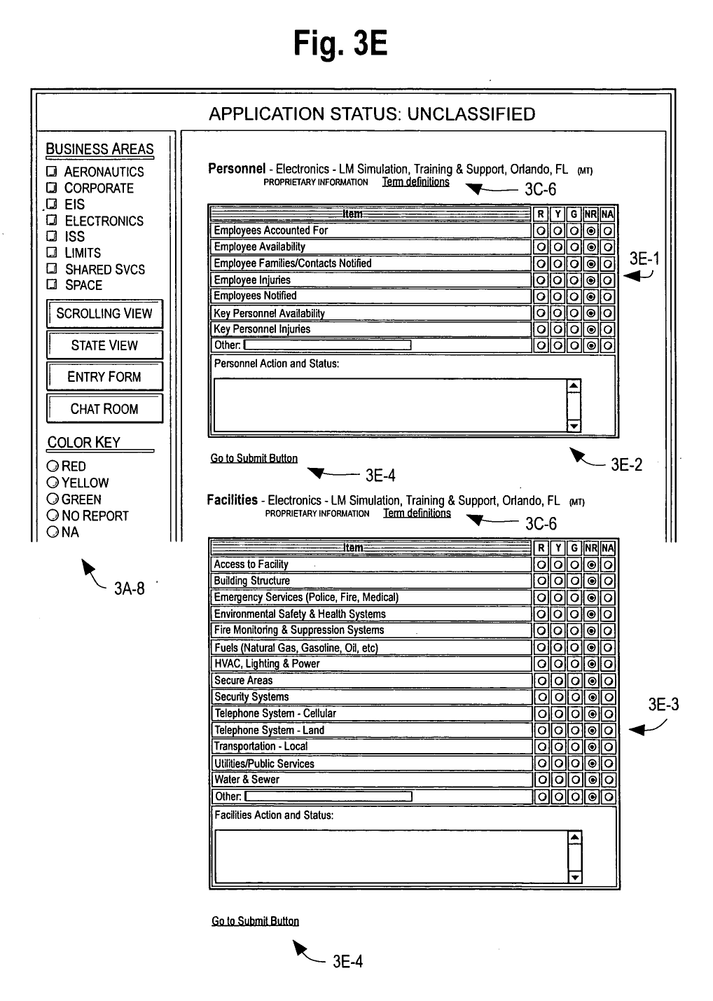

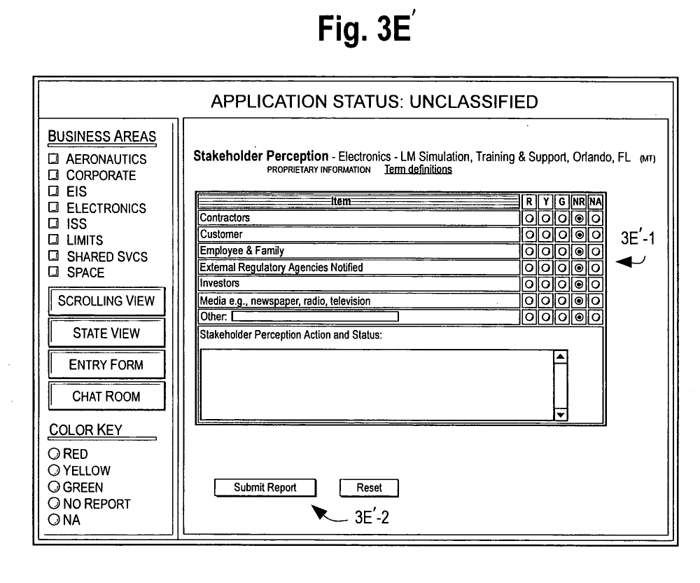

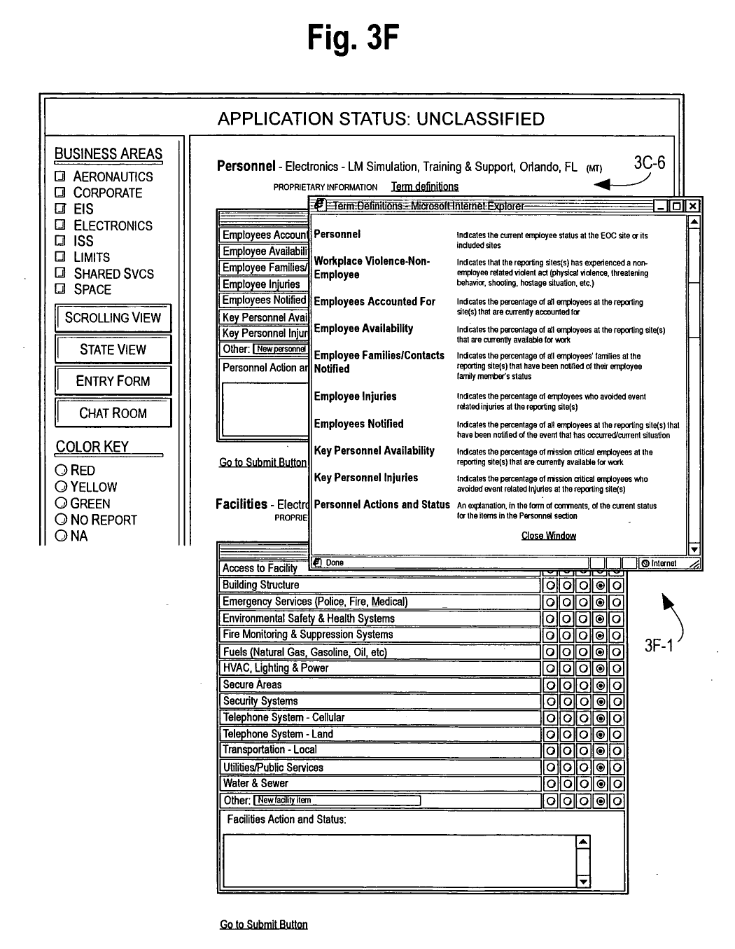

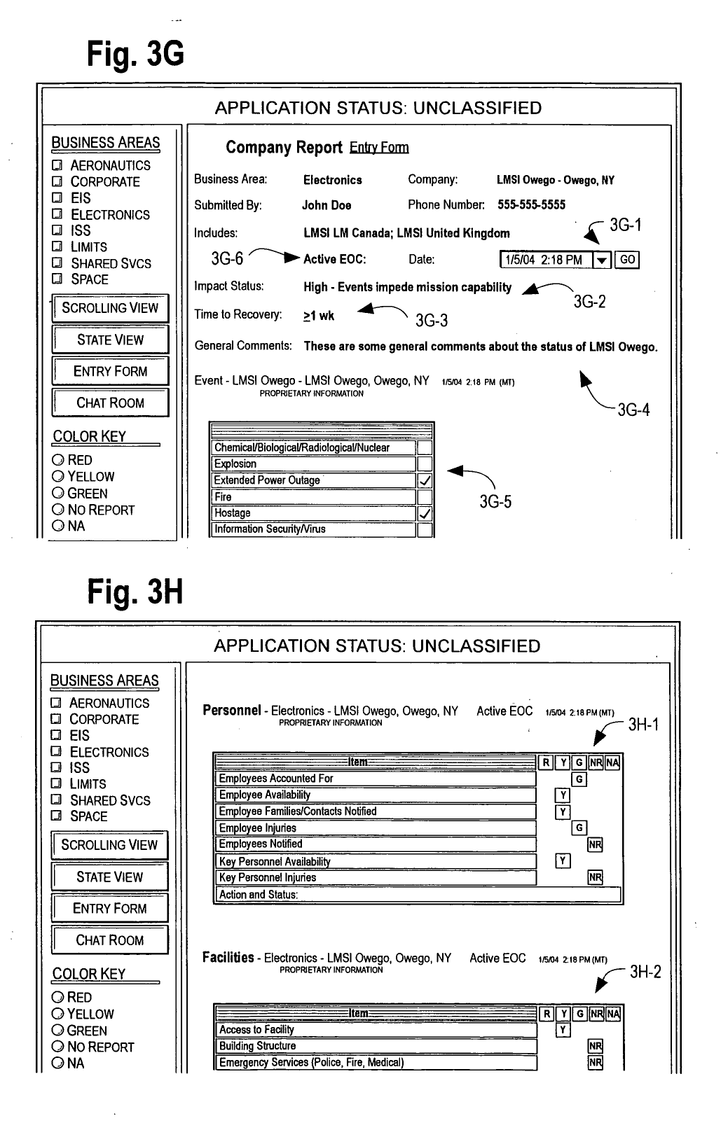

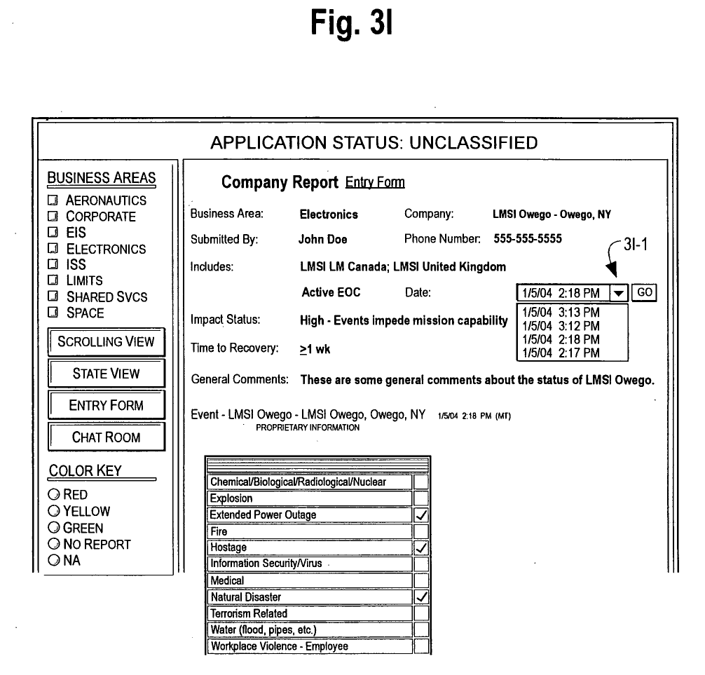

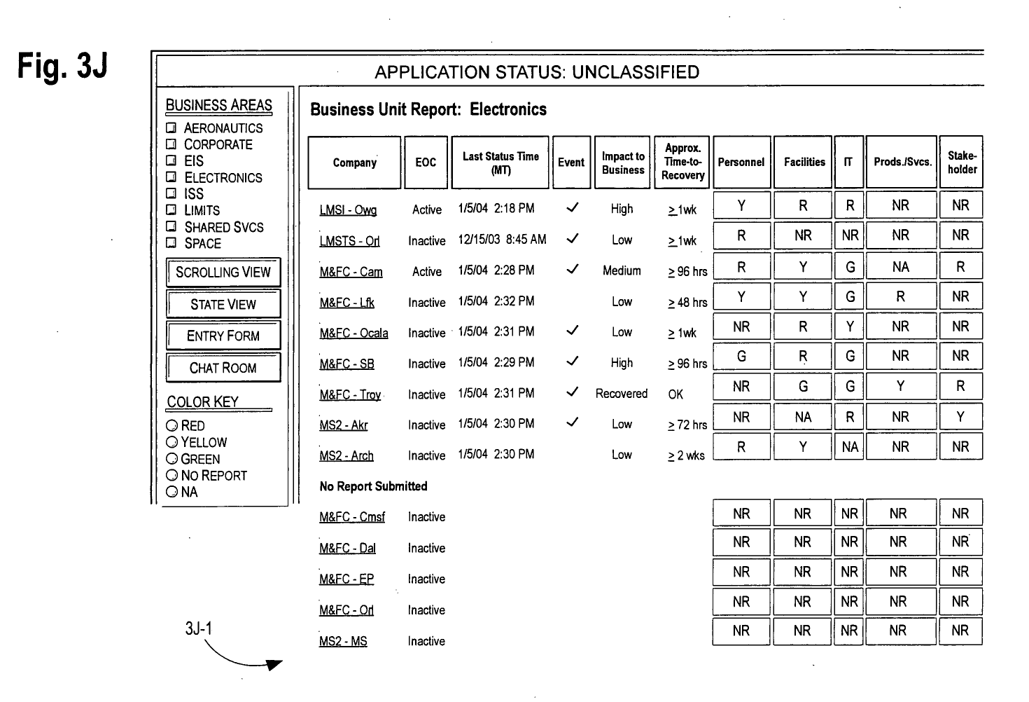

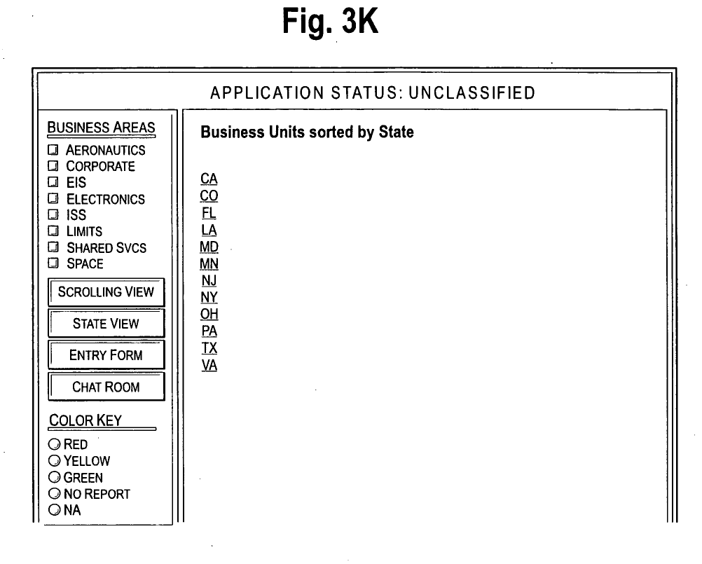

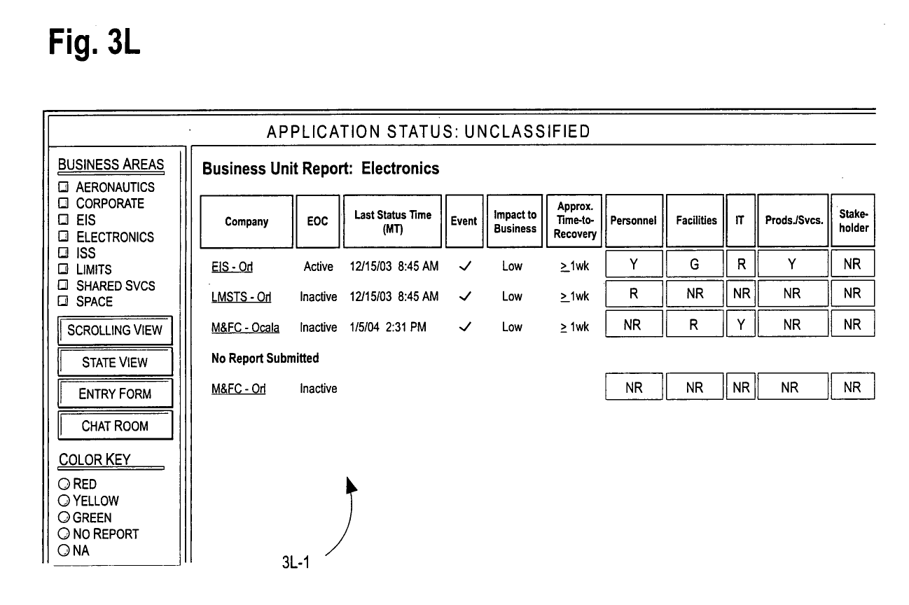

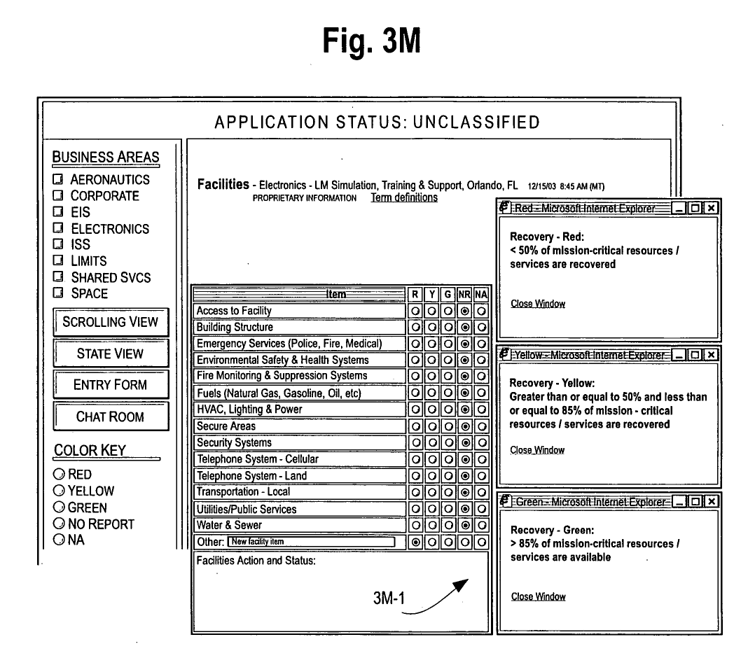

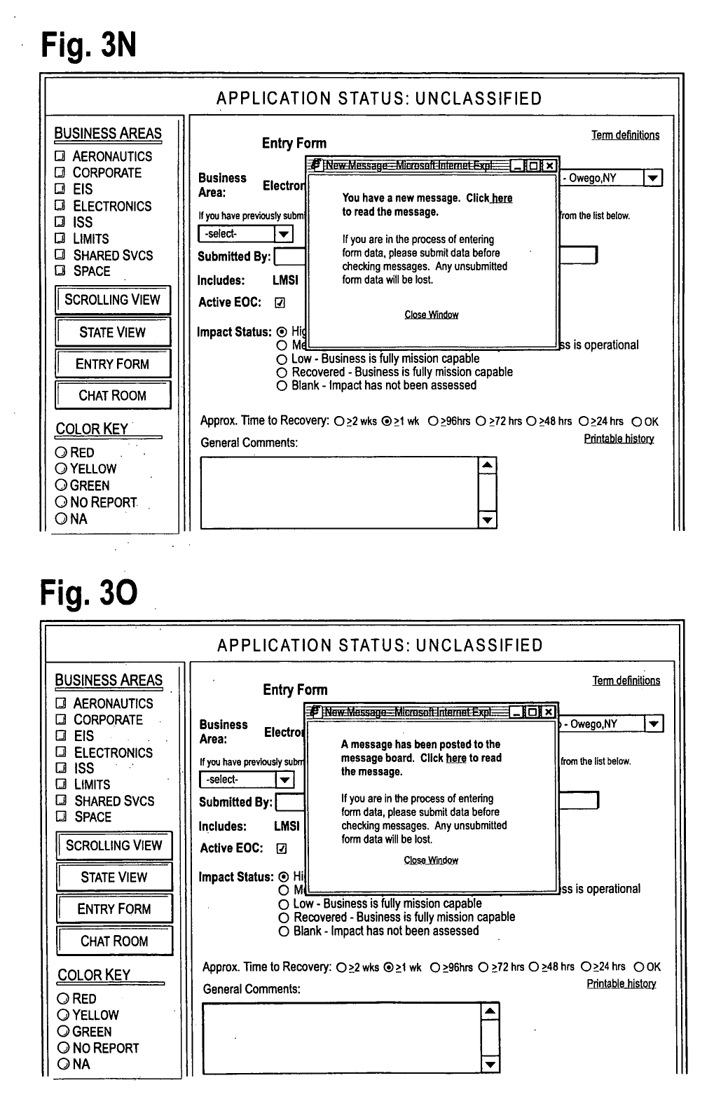

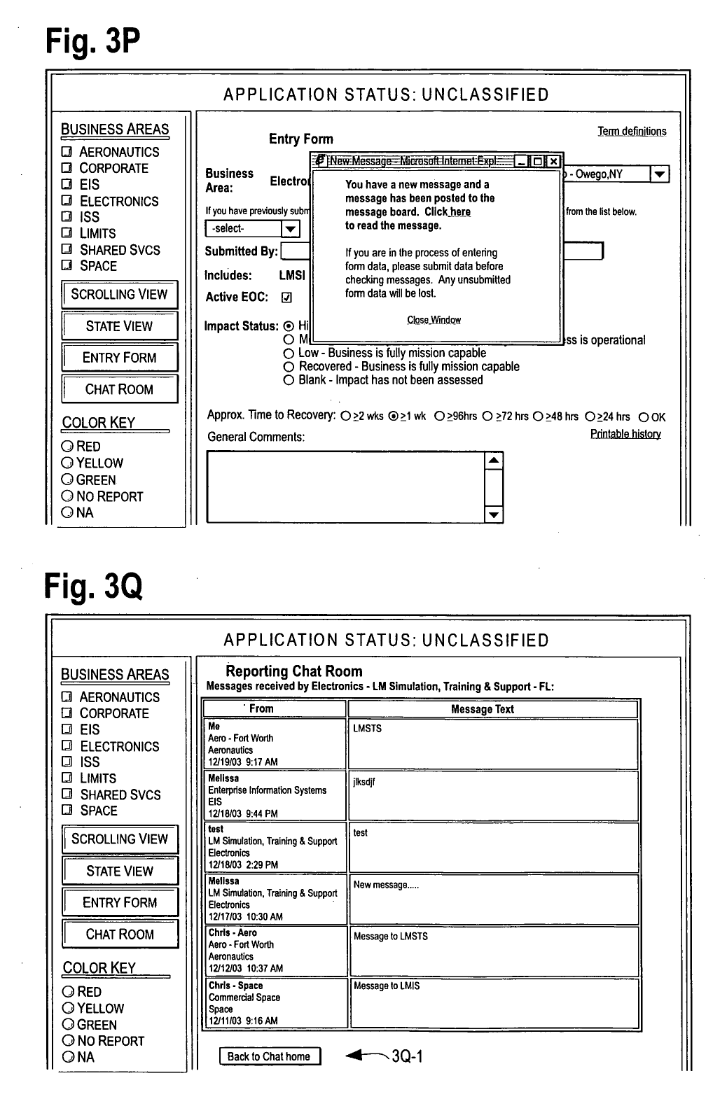

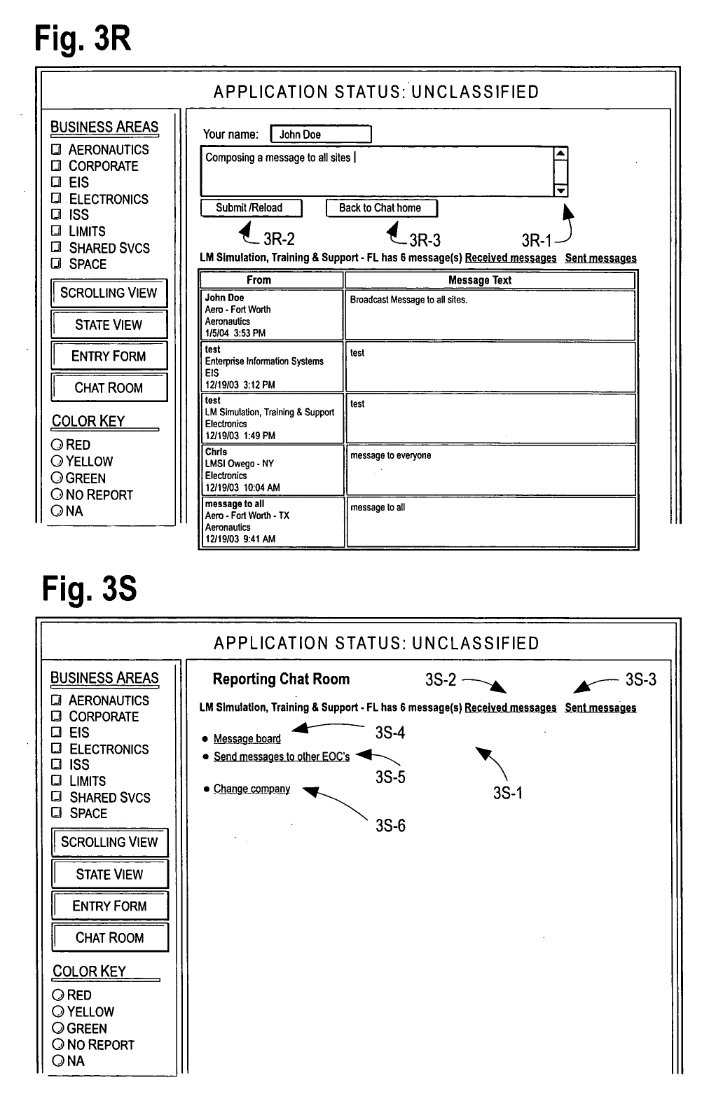

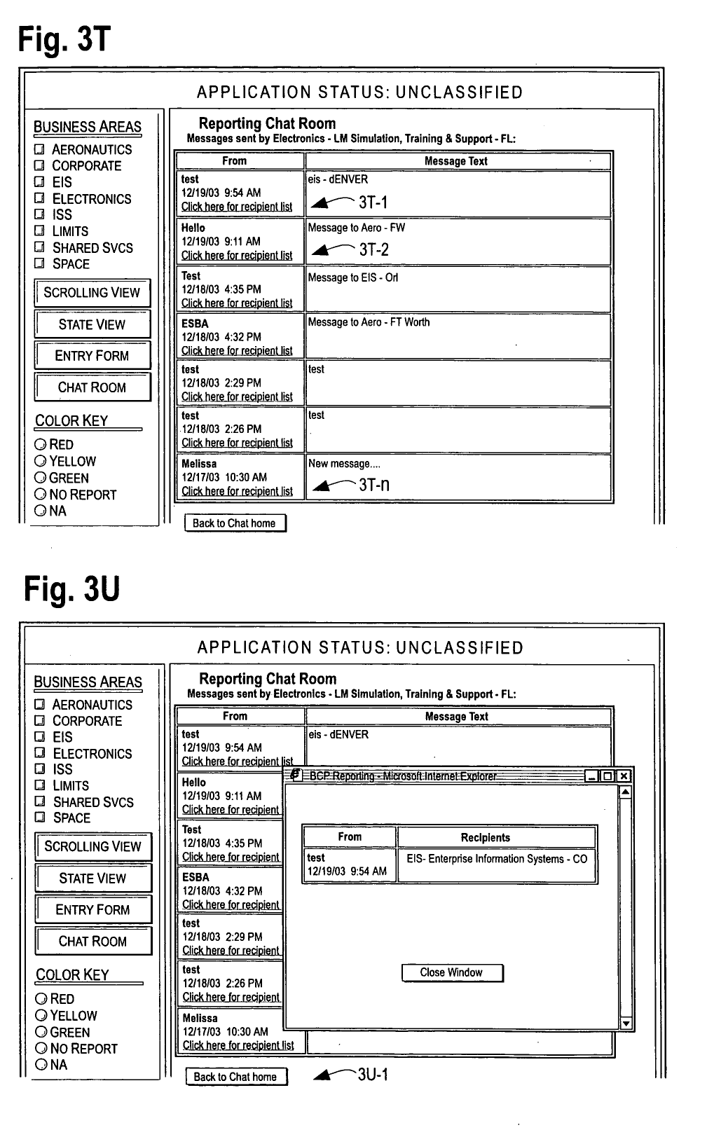

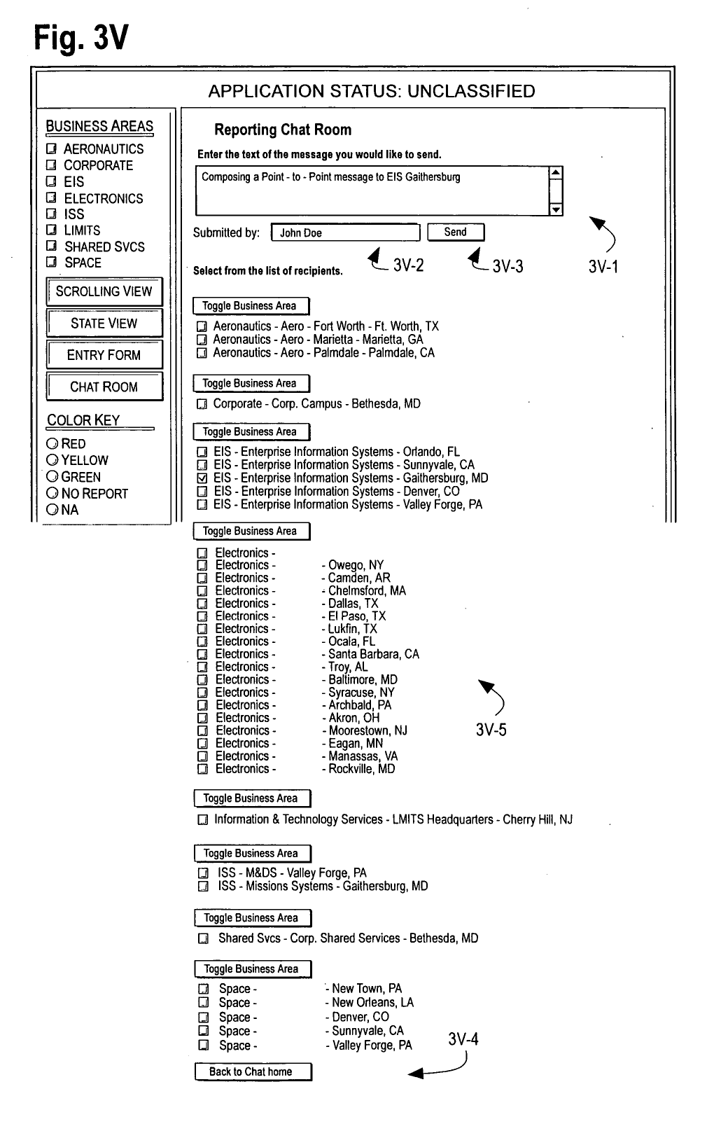

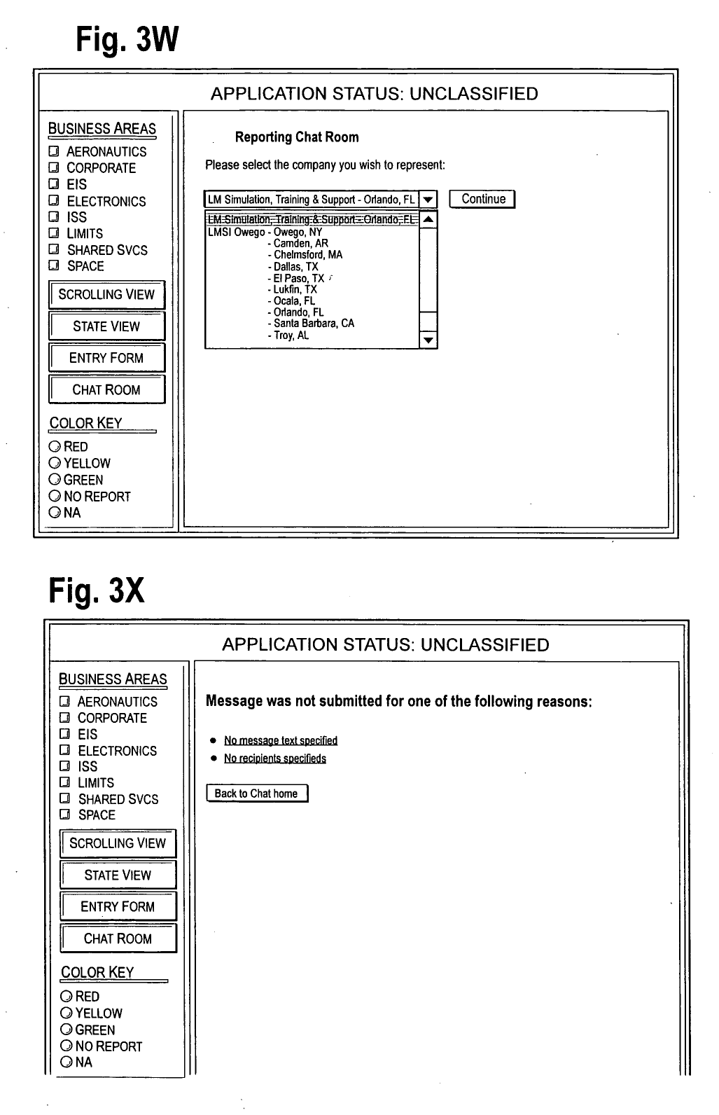

FIGS. 2A through 2G illustrate methods in accordance with the present invention. FIGS. 3A through 3X illustrate various screens presented to a user, operator or reporting individual while carrying out the methods of FIGS. 2A through 2G.

FIG. 2A illustrates steps of a method 100 in accordance with the invention. In a step 102, system home page is displayed, see FIG. 3A. The home page of FIG. 3A can be presented at any of the reporting devices such as 12-1 . . . -n, without limitation. The home page of FIG. 3A includes regions (entry points) for entering user name and authorizing password indicated generally at 3A-1. The home page also displays a table of contents indicated generally at 3A-2.

The members, the items in, table of contents at 3A-2 are active and can be selected (clicked on) by a user. In section 3A-3, a business area (e.g., business organization) can be designated. In section 3A-4 a scrolling view of various screens, see FIG. 2F, can be presented for a user. In region 3A-5, a geographic select screen, see FIG. 2E, can be presented which enables a user to select facilities by state or other geographical area.

Region 3A-6 of the table of contents displays an entry form screen, see FIGS. 3B through 3E′. Region 3A-7 of the table of contents provides access to chat room screens, see FIG. 2G as well as screens of FIGS. 3N through 3X. Finally, region 3A-8 of the table of contents enables a user to select each of the color keys and obtain further information as to the definition thereof. It will be understood that a user can always switch screens using the Table of Contents 3A-2.

With reference to FIG. 2A, in a step 104, the user enters a user name and password, region 3A-1 of FIG. 3A to log on. The entry form screen can then be selected in step 106. If selected, the screen of FIG. 3B is presented to the user for purposes of specifying a business area illustrated generally in region 3B-1 and to select a company emergency operation center, EOC, to represent from the company pulldown menu 3B-2.

Those of skill will understand that while the illustrative screens of FIGS. 3A through 3X are presented in the context of commercial entities, such as corporations having business areas, companies or facilities, as are the screens of FIGS. 3A-3G, it will be understood that the invention is not limited thereto. The invention has broad applicability to various forms of entities which could include governmental, academic, non-profit entities and the like, all without limitation.

Subsequent to selecting the company emergency operations center, which the user represents, step 108, the entry form page FIG. 3C is displayed. In the screen of FIG. 3C, region 3C-1 enables a reporting individual to identify themselves by name and phone number. Region 3C-2 enables the user to designate an active/inactive emergency operation center (EOC). It will be understood that the system 10 supports reports from any authorized individual who is logged on whether that individual represents an active emergency operations center or not.

The reporting individual in region 3C-3 can designate the impact status of the event on the designated business area and company/location. In region 3C-4, approximate time to recovery can be indicated. In region 3C-5 general additional comments can be entered by the reporting individual which might be helpful to those reviewing the report in assessing the impact of the event on operations. In region 3C-6, the individual can click on “term definitions” for purposes of obtaining a display of definitions of various terms used in the form, see FIG. 3F.

As discussed in more detail, subsequently, a variety of status information can be provided by the reporting individual as to the condition of the entity or location to which the report pertains. It will be understood that all such information is exemplary only and should not be considered as limitations of the present invention.

In region 3C-7 the type of event can be designated. Unlisted events can be designated in region 3C-8.

Relative to step 106, FIG. 2A, instead of selecting the entry form page, one of the regions of the table of contents can be selected, step 112. If a business unit report page is to be reviewed, step 114 a business area can be selected from the table of contents step 116. The respective business unit report page will then be displayed, see screen of FIG. 3J, step 118. If the scrolling view page is to be presented, step 120, that view can be selected from the table of contents step 122. The scrolling view screens can then be subsequently presented, see FIG. 2F, step 124. If entities or facilities are to be reviewed based on geographic location, step 126, the state view page can be selected from the table of contents step 128. The state view selection screen can then be presented to the user, step 130, FIG. 3K. Finally, if the user wishes to review messages or send messages, the chat room can be selected from the table of contents, step 132, which in turn presents the chat room page, 134, see FIG. 2G.

FIG. 3D illustrates a follow-on reporting screen, similar to the screen of FIG. 3C, which represents a screen presented for an initial report. The screen of FIG. 3D represents a screen presented for entry of a subsequent report. In this regard, region 3D-1, identities previous reporters as well as phone numbers to facilitate inserting the appropriate information into the reporter identification regions, see 3C-1 of FIG. 3C. Additionally, the entry screen of FIG. 3D incorporates a “printable history” button 3D-2 which can be selected for purposes of presenting and/or printing a previously entered and stored company report screen, see FIGS. 3G, H, and I. Otherwise, the screen of FIG. 3D is the same as the screen of FIG. 3C previously discussed.

The screen of FIG. 3E, an extension of either of the entry form screens, 3C, 3D, can be used to specify employee or facility status in response to the event. Status indications can be provided on a color coded basis by selecting the appropriate entry in the red, R, yellow, Y, or green, G columns as appropriate. A no report, NR, and a non-applicable, NA, column are also provided to be used as appropriate. In the event that a user is uncertain as to the definitions of the color codings, region 3A-8 of the menu can be used to select a definition of the meaning of the various color coded elements, see FIG. 3M.

In region 3E-1, reporting personnel can enter personnel status information or the like as appropriate. In region 3E-2 the reporter can incorporate additional textual details including their interpretation as to the meaning of the selected color coding for the various categories. The region 3E-2 can be used to provide additional reporting information without limitation. Access and condition of facility, or structure can be specified on the same screen in region 3E-3. Finally, when the relevant information has been entered by the reporter, it may be submitted to the system for storage and retrieval purposes by clicking on “Go to Submit” button 3E-4.

The screen of FIG. 3E′ provides a region 3E′-1 to report perception of various parties in response to the event. The report can be entered into the database 26 by clicking on the “Submit Report” button at region 3E′-2. The Reset button shown in FIG. 3E′ may be selected to replace the present contents of the screen with its prior contents.

As noted above, the screen of FIG. 3F presents a window of term definitions 3F-1 in response to a reporter clicking on the “term definitions” hyperlink 3C-6.

The screens of FIGS. 3G, 3H and 3I illustrate an exemplary company report based on previously entered information by a reporter. In FIG. 3G, each company report is tagged with date and time of entry, see region 3G-1. Each submitted report is retrievable via its date and time of entry. Hence, all earlier entries can be reviewed to provide a history of prior reports.

As illustrated on FIG. 3G, impact status is indicated in region 3G-2 and estimated time to recovery is indicated in region 3G-3. Previously entered general comments can be read in region 3G-4. The type of event has been indicated in 3G-5. The illustrated report was entered by an active EOC, region 3G-6.

The company report continues on screen 3H which illustrates previously reported employee status, see region 3H-1, and facility status, see region 3H-2.

FIG. 31 is a variation of the screen of FIG. 3G illustrating in region 3I-1, dates and times of previously entered reports which can be retrieved as desired to review one or all of the members of the sequence. Such reports can be useful in providing trend information to management as the information contained therein varies over time.

FIG. 2B illustrates various aspects of entry form processing method 140. The entry form page, FIG. 3C is displayed, step 110. In step 142, the current company EOC status is entered on the region 3C-2. The reporter can also enter identifying information, region 3C-1.

If desired, color key definitions can be viewed, see FIG. 3M, region 3M-1, by selecting same via the table of contents, region 3A-8, step 144. As noted above, the relevant areas of the table of contents can be selected at any time during the process.

In a step 148, if the first status report is to be provided if desired, term definitions can be viewed, step 150 by clicking on active region 3C-6, see FIG. 3F. When the reporter has completed entering the information on the entry screen, step 154, it can be submitted for storage, step 158 by clicking on the “submit report” active region 3E′-2. In such event, the company report page is presented, FIGS. 3G, 3H, 3I previously discussed, step 160. Otherwise, an entry can be selected from the table of contents, step 162.

Where previous status reports have been entered, one or more of such reports can be selected via the printable history link 3D-2, step 164.

FIG. 2C is a flow diagram 180 illustrating steps of business unit report page processing. Where the business unit report page option has been selected, step 118, in step 182, screen 3J is presented for examination. It will be understood that the business unit report page might be of interest to organizational management, stakeholders, vendors and the like, all of whom have an interest in the ability of the entity to continue its normal performance notwithstanding the presence of one or more disruptive events.

In step 182, screen 3J presents status information pertaining to all of the company's facilities or the like associated with a particular selected business unit. Business units or business areas of interest can be selected from the table of contents region 3A-3. The summary information provided on screen 3J, step 182, provides access to additional detailed information for each of the indicated companies or facilities listed in region 3J-1. It will also be understood that when the screen of 3J has been presented for consideration, the table of contents and region 3A-3 can be used to switch between business unit or business areas.

Where more specific information is desired in connection with one or more of the companies or facilities listed, step 184, any of the listed companies or facilities can be clicked on or selected in the region 3J-1, step 186 to present one or more of that company's or facilities status reports. In such an event, one or more company report pages can be presented for review and consideration, step 188. Alternately, step 190 where the viewer has logged in in connection with the selected business unit or business area, one or more incomplete reports can be viewed, step 192. Where the viewer has not logged into the particular business area, step 190, another business area can be selected for review from the table of contents 194. Alternately, the system returns to step 102, FIG. 2A.

FIG. 2D illustrates company report page processing method 200 where a company has been selected, step 188, FIG. 2C whose reports are to be reviewed. In step 202 the most recent status report of the selected company is presented for review, see FIGS. 3G, 3H. In step 206, where previously submitted status reports are to be viewed, one or more previously submitted status reports can be selected by date and time from the date dropdown menu, see FIG. 3I. These reports can be reviewed and/or printed for archival purposes illustrating ongoing trends as reflected by the historical reports. Where the viewer has been logged in under the selected business area, a new report can be entered relative to that company or facility, step 208. Alternately, the viewer can select another option from the table of contents, step 102.

Where the user or reviewer has selected the “state view” option from the table of contents, step 130, FIGS. 2A and 2E, facilities or companies of the selected business area or business unit are sorted by state and a list of states is presented in the screen of FIG. 3K. In a step 222, the user can select a state or geographical area of interest and the system will present a business unit report for the selected state, see screen of FIG. 3L. The summary business unit report of screen FIG. 3L can then be used to select one or more companies or facilities, from region 3L-1, whose respective company report or reports are to be reviewed, step 188, FIG. 2D.

Where the viewer wishes to have an overview of conditions of various business units or areas, the scrolling view button 3A-4 can be selected in the table of contents. FIG. 2F illustrates scrolling view methodology and processing 230.

In a step 232, the current, or first, business unit for example, aeronautics, is selected and the respective business unit or business area report is presented for a brief interval, such as for example 5 seconds, to the user. During this presentation, if status information pertaining to a particular company or facility is of interest, step 234, the respective company or facility can be selected, step 236, thereby exiting the scrolling processing of FIG. 2F. The respective company report will then be presented, step 188.

Alternately, if the viewer has not been logged in to the business area or unit whose report is being presented, step 238, another business area report can be viewed if desired, step 240, at the end of the current display cycle, step 242 for the present business area or unit. In this fashion, each of the business areas or units can be reviewed in summary form in a relatively short period of time to provide overall corporate status information.

Where the user has been logged into a particular business area, if desired, an incomplete company report can be selected for review, step 246. Thus, the “scrolling view” feature cyclicly presents each of the business area of business unit reports one after the other until the user makes another selection.

The system 10 supports a variety of messaging formats. Point-to-point messages can be sent between companies or facilities. A source can broadcast a message to designated recipients. Additionally, bulletin board functionality is available for posting messages.

As illustrated in FIGS. 3N, 3O, 3P, one way in which to become aware of one or more messages is to receive a pop-up window on an entry form while status information is being entered. In each of FIGS. 3N, 3O, 3P, the message or bulletin board posting can be responded to once the data has been submitted, so as to avoid losing same. If on the other hand, the information has not yet been entered into the entry form, each of the pop-up messages can be responded to by clicking on same in the indicated region so as to read the subject message.

Screen 3Q illustrates point-to-point messages received by the designated business area and company/facility. The screen of FIG. 3R lists broadcast messages which have been received and which have been sent.

Alternately, the chat room can be entered via the table of contents which in turn will present the screen of FIG. 3S to the user. The screen of FIG. 3S provides options to the user. The number of messages sent and received is shown in FIG. 3S-1. To review received messages, region 3S-2 can be selected. Region 3S-3 can be selected, clicked on. To review messages sent to other EOCs region 3S-3 can be selected.

Where the message board has been selected, region 3S-4, the screen of FIG. 3Q presents messages received on the message board. Where the “send messages” region 3S-5 is selected, the screen of FIG. 3T lists previously sent messages. The screen of FIG. 3R provides a composing area, region 3R-1 where a broadcast message can be composed to be sent to all sites. The screen of FIG. 3V provides a composing area region 3V-1 in which a point-to-point message can be composed. The recipients can be identified as indicated generally in region 3V-5. Finally, the selected company or facility can be changed where region 3S-6 of the screen of FIG. 3S has been selected, see FIG. 3W.

The flow diagram of FIG. 2G illustrates chat room processing 260. In accordance with Chat Room Processing step 260, FIG. 2G, a user can compose messages to the other Company EOC's, read messages sent directly to the Company EOC that the user represents and read broadcast messages sent to all Company EOC's by system 10.

A user can access the Chat Room by clicking on the Chat Room Button 3A-7 in the Table of Contents 3A-2. If a Company EOC has not been selected the user will be asked to select a Company EOC step 262 in the Business Area that the user logged in under, from a Company drop down menu (FIG. 3W). Once a user has selected a Company EOC step 264, the Reporting Chat Room Page FIG. 3S for the represented Company EOC will be displayed, step 266. If Company EOC has been selected prior to displaying the Chat Room screen, the user will automatically be taken to the Reporting Chat Room screen, step 266 and will not be asked to select a Company EOC from the Company dropdown menu.

Once the Reporting Chat Room page has been displayed, step 266, the user will see the name of the Company EOC on the top of the page (FIG. 3S). To the right of the Company EOC name, the number of messages sent directly to that Company EOC will be displayed, region S3-1. The number of messages 3S-1 takes into account both read and unread messages.

Clicking hyperlink 3S-2 will enable a user to view all messages sent directly (point-to-point) to the designated Company EOC. System 10 will display each message, the Company EOC that sent each message, the designated Business Area represented and the date and time of when each message was sent (FIG. 3Q). Clicking the “Back to Chat Home” button, 3Q-1 returns to the Reporting Chat Room page, FIG. 3S.

Clicking the Sent Messages hyperlink, step 268, will enable the user to view all messages, step 270, FIG. 3T that have been sent directly (point-to-point) to other Company EOCs. Each entry includes a button, such as 3T-1, -2, . . . -n enabling a user to view a recipient list step 272, FIG. 3U.

Clicking a recipient list such as 3T-1 enables a user to view each Company EOC(s) to which a corresponding message was sent, step 274. System 10 will open up another window which displays the Company EOC(s) who received the message, the Business area they represent, and the date and time of when the message was sent (see FIG. 3U) Clicking the Back to Chat button 3U-1 returns to the Reporting Chat Room page, FIG. 3S. A Message Board page is available to view and send broadcast messages to all Company EOC's at one time.

From the Reporting Chat Room page, FIG. 3S, the Message Board can be accessed, step 276, by clicking on the Message board hyperlink. System 10 will display each broadcast message, the Company EOC that sent each message, the Business Area they represent and the date and time of when each message was sent (FIG. 3R).

At the top of the page there is an area 3R-1 where a user can compose broadcast messages to be sent to all Company EOCs. A user enters a name in provided textbox and composes the message in the textbox provided directly below, step 280. Clicking Submit/Reload button 3R-2 sends the message to all of the Company EOCs. If no text has been entered in either of the provided textboxes, clicking the Submit/Reload button 3R-2 will refresh the page and no message will be sent. Clicking the Back to Chat home button 3R-3 will cancel the message prior to sending it and will display the Reporting Chat Room screen FIG. 3S.

Clicking Send messages to other EOCs 3S-5 can be used to send messages directly (point-to-point) to other Company EOCs, step 282. The screen of FIG. 3V is then displayed. An area at the top of the page is provided 3V-1 where a user can compose a message FIG. 3V, step 284. A user enters a name in the provided textbox, 3V-2 and composes the message in the textbox provided directly above 3V-1.

A user can then choose the Company EOCs to send the message to, see list of recipients shown in region 3V-5. The Company EOCs are sorted by the Business Area. System 10 provides checkboxes next to each Company EOC.

The checkbox next to the Company EOC(s) is selected to specify where the message is to be sent. Clicking the Toggle Business Area button will select all of the checkboxes in the corresponding Business Area so that a user can send a message to each Company EOC in the selected Business Area.

Clicking the Send button 3V-3 sends the message to the selected Company EOCs. Clicking the Back to Chat home button 3V-4 will cancel the message prior to sending it and will take the user back to the Reporting Chat Room Page, FIG. 3S.

On FIG. 3S, clicking the Change Company hyperlink, step 286 enables a user to change the Business Area Company EOC represented in the Reporting Chat Room. After clicking the Change Company hyperlink, system 10 will display the screen with a Company dropdown menu (FIG. 3W). The Company dropdown menu enables a user to select a Company EOC, in the logged in Business Area to represent in the Reporting Chat Room as discussed above.

The above screens and processing are exemplary only. The present invention is applicable to governmental, academic, or non-profit entities without limitation. Similarly, the above description in terms of corporate structures is also exemplary only. None of the above described details are limitations of the invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modification as fall with the scope of the claims.

What is claimed is:

1. A reporting system comprising:
a plurality of reporting devices in communication with at least one computer network;
a storage unit in communication with the at least one network;
software installed on at least one reporting device and operable for entering information about operating conditions, including operations impacted by selected events, the entered information being stored in and retrievable from the storage unit from at least one other device.

2. A system as in claim 1 which includes software enabling information to be entered at a plurality of reporting devices in connection with the impact of the event.

3. A system as in claim 1 which includes graphical user interface software that presents an information entry screen for specifying the impact of the event relative to the selected entity.

4. A system as in claim 3 where the entry screen comprises an activity-type specification region.

5. A system as in claim 4 where the entry screen comprises an entity specification region.

6. A system as in claim 3 where the entry screen comprises an entity specification region.

7. A system as in claim 4 where the interface software presents a plurality of selectable, different impact indicating indicia.

8. A system as in claim 7 where the indicia are color coded.

9. A system as in claim 3 where the interface software presents a plurality of selectable, different impact indicating indicia.

10. A system as in claim 9 where the indicia are color coded.

11. A system as in claim 7 which includes at least first and second color coded pluralities of indicia where each plurality is associated with a selected functionality parameter.

12. A system as in claim 7 with the software associating a date and time with entered information.

13. A system as in claim 12 with the software receiving and storing reporting personnel identifying indicia.

14. A system as in claim 12 with the reporting devices spaced apart physically and in one of wired or wireless communication with the computer network.

15. A system as in claim 12 where the software provides a textual entry region on the entry screen.

16. A system as in claim 12 where the software retrieves selected, previously entered data in response to a request.

17. A system as in claim 1 which includes software for presenting previously entered entity related condition related information.

18. A system as in claim 17 which includes additional software for transmitting point-to-point messages between reporting devices.

19. A system as in claim 17 which includes additional software for broadcasting messages to a plurality of reporting devices.

20. A system as in claim 17 which includes geographical region specifying software for identifying a selected region, and for presenting condition related information pertaining to at least one selected entity in the selected region.

21. A system as in claim 20 where the computer network comprises one of an Internet or an intranet.

22. A web based status reporting system comprising:
first software for displaying a user reporting screen with color coded status showing indicia associated at least with a specified entity; and
second software for transmitting at least the reported indicia, via a computer network, to a database.

23. A system as in claim 22 which includes software enabling a reporter to enter textual information into the screen for transmission to the database.

24. A system as in claim 23 which includes software enabling a plurality of users to retrieve information from the database, via the network for a selected entity.

25. A method comprising:
entering a plurality of reports pertaining to conditions at a selected entity as a result of an event;
transferring the reports, via a computer network, to a destination;
storing the reports at the destination; and
accessing at least some of the reports, via the computer network, to determine conditions at the selected entity.

26. A method as in claim 25 which includes sending messages between a source and a selected destination.

27. A method as in claim 25 which includes broadcasting messages from a source to a plurality of destinations.

28. A method as in claim 25 which includes posting at least one message to a bulletin board.

29. A method as in claim 25 which includes logging onto and being authorized to enter at least some of the reports.

30. A method as in claim 25 which includes encrypting at least some of the reports prior to the transferring step.

31. A method as in claim 25 which includes decrypting reports as necessary prior to storing same.

32. A method as in claim 25 which includes storing the reports redundantly.

33. A method as in claim 25 which includes incorporating color coded, condition specifying indicia into the reports.

34. A method as in claim 25 which includes specifying a geographical region relative to which reports are to be accessed.

35. A method as in claim 25 which includes specifying an entity activity area.

36. A method as in claim 35 which includes specifying one of a business entity, or, a facility.

37. A method as in claim 36 which includes accessing reports associated with the specified activity area and the specified one of the business entity, or facility.

38. An operation-condition reporting system comprising:
first software enabling a user to select an entity;
second software for entering status information pertaining to the impact of an event on the performance of the selected entity;
third software for recording the status information, including an associated time and date, in a database; and
fourth software enabling a plurality of users to access the database via a computer network.

39. A system as in claim 38 where the first software enables a user to specify an entity and a subset thereof.

40. A system as in claim 39 where the entity comprises a corporate business area and the subset comprises one of a company, division or facility in the business area.

41. A system as in claim 38 which includes additional software enabling a user to review a sequence of previously entered status information pertaining to the selected entity.

42. A system as in claim 40 which includes additional software enabling a user to review a sequence of previously entered status information pertaining to the selected company, division or facility.

43. A system as in claim 38 where the status information pertains to at least one of personnel or physical plant.

44. A system as in claim 38 where the status information is at least in part color coded.

45. A system as in claim 43 where the status information is at least in part color coded.

46. A system as in claim 38 which includes additional software enabling a plurality of reporters to enter status information, via the computer network into the database.

47. A system as in claim 46 which includes software enabling a user to review a plurality of previously entered status reports.

48. A system as in claim 38 which includes message creation and transmission software.

49. A system as in claim 48 where the messages can be sent to one of a specific recipient or a plurality of recipients.

50. A system as in claim 48 where messages can be posted to a bulletin board.

51. A system as in claim 47 which includes message creation and transmission software.

52. A system as in claim 38 which includes graphical user interface software that presents at least one screen for entry of status information.
